(19) United States
(12) Patent Application Publication
(10) Pub. No.: US 2006/0259602 A1
(43) Pub. Date: Nov. 16, 2006

(54) Method and apparatus for transport level server advertisement and discovery

(76) Inventors: Randall Stewart, Chaplin, SC (US); Dana Blair, Alpharetta, GA (US); Peter Lei, Arlington Heights, IL (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/128,776

(22) Filed: May 12, 2005

(51) Int. Cl. G06F 15/173

(52) U.S. Cl. 709/223

(57) ABSTRACT

A method and apparatus is disclosed for transport level server advertisement and discovery. First information is received at a transport protocol stack. The transport protocol stack recognizes that the first information represents one or more services provided by a server. Based on the first information, the transport protocol stack determines whether to use any of the one or more services.

### FIELD OF THE INVENTION

The present invention generally relates to networking and network services. The invention relates more specifically to a method and apparatus for transport level server advertisement and discovery.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Service discovery is a well-known problem in the area of inter and intra network communications. For example, suppose that a server is started on a computer system that is communicatively connected to a network, and that the server is configured to offer one or more services to potential clients. The potential clients, however, are unaware that the server exists or has started and cannot avail themselves of the services offered by the server. Thus, an additional mechanism is needed to provide for discovery of the server and its services by the potential clients.

One past approach to address the service discovery problem is for the server to join a multicast server group. The potential clients then send advertisements in a multicast communication to the multicast group seeking out particular services. The servers receive the advertisements and respond to the clients with offers for service. One of the main disadvantages of this approach is that the potential clients need to send multiple communications before the discoveries of a server and its services are made.

One mechanism that is a variation of this past approach is the RSERPOOL (Reliable Server Pooling) technique that is described in draft-ietf-rserpool-arch-08.txt, which was published by the Internet Engineering Task Force on Oct. 24, 2004. The RSERPOOL technique is used to provide support for a particular service by a plurality of servers. This is achieved by forming a pool of servers, each of which supports the particular service, and by providing a name service that resolves requests from a client to the identity of a working server in the pool. To use a desired service, the client consults a name server that provides the name service. The name service provides the client with the identity of a server in the server pool that supports the service desired by the client. Based on the information received from the name service, the client then establishes a transport connection to the server to use the desired service. Thus, in addition to the disadvantage of requiring the client to send multiple communications, the RSERPOOL technique also has the disadvantage of using a middle layer (the name service) for discovering a server that provides the desired service.

Another past approach to address the service discovery problem is for the server to advertise a service using User Datagram Protocol (UDP), which is a connectionless transport protocol. The client listens on its UDP port for datagrams that advertise a service, and then decides whether to establish a transport connection to the service over a connection-oriented transport protocol, such as a Stream Control Transmission Protocol (SCTP) or a Transmission Control Protocol (TCP).

One disadvantage of this approach is that it requires the client to use at least two separate and distinct transport protocols before the client can access a desired service. Typically, connection-oriented transport protocols, such as SCTP or TCP, do not pay attention to, and usually discard, information received in multicast or broadcast transmissions because such information is not associated with any transport connection established at the client according to the connection-oriented transport protocol. For this reason, a connectionless transport protocol, such as UDP, is used for the discovery of the desired service, and a connection-oriented protocol, such as SCTP or TCP, is used to actually access the service. The use of separate protocols for the discovery and access to the service, however, may not be desirable because of the overhead associated with the use of an additional transport protocol. For example, use of an additional transport protocol usually requires use of additional computing resources, such as memory and network bandwidth, and introduces additional security and authentication concerns.

Another disadvantage of this approach is that it does not work at all if the client is not configured to use a connectionless transport protocol, such as UDP. And it will not work if the network that the client and server are attached to is not explicitly configured to pass broadcast and/or multi-cast packets.

Based on the foregoing, there is a clear need for a technique providing transport level server advertisement and service discovery that overcomes the disadvantages of the approaches described above.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates an overview of an operational context in which an embodiment may be implemented;

FIG. 2A is a flow diagram that illustrates a high level overview of one embodiment of a method for transport level server advertisement and discovery;

FIG. 2B is a flow diagram that illustrates one embodiment of a technique for transport level service discovery implemented according to Stream Control Transmission Protocol (SCTP);

FIG. 2C is a flow diagram that illustrates one embodiment of a technique for transport level service discovery implemented according to Transmission Control Protocol (TCP);

FIG. 3A is block diagram that illustrates an example format of an SCTP Service Discovery chunk according to one embodiment;

FIG. 3B is block diagram that illustrates an example format of a TCP Options flag according to one embodiment; and

FIG. 4 is a block diagram that illustrates a computer system upon which an embodiment may be implemented.

### DETAILED DESCRIPTION

A method and apparatus for transport level server advertisement and discovery is described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Embodiments are described herein according to the following outline:
1.0 General Overview
2.0 Structural and Functional Overview
3.0 Method of Transport Level Server Advertisement and Discovery
   3.1 Server Advertisement and Discovery over SCTP
   3.2 Server Advertisement and Discovery over TCP
   3.3 Forwarding Service Advertisements
4.0 Implementation Mechanisms-Hardware Overview
5.0 Extensions and Alternatives
   1.0 General Overview

The needs identified in the foregoing Background, and other needs and objects that will become apparent for the following description, are achieved in the present invention, which comprises, in one aspect, a method for transport level server advertisement and discovery. First information is received at a transport protocol stack. The transport protocol stack recognizes that the first information represents one or more services provided by a server. Based on the first information, the transport protocol stack determines whether to use any of the one or more services. In a feature of this aspect, the transport protocol stack operates according to a connection-oriented transport protocol.

In one feature of the aspect, in determining whether to use any of the one or more services, the transport protocol stack notifies a client about the one or more services. The client utilizes the transport protocol stack, and transport protocol stack may notify the client by sending the first information. In response to a decision by the client to make use of a particular service of the one or more services, a transport connection is established to the server in order to request the particular service. After establishing the transport connection to the server, the client may request authentication of the particular service from the server.

In a feature of this aspect, second information is registered with the transport protocol stack. The second information indicates a specific service in which a client that utilizes the transport protocol stack is interested. The transport protocol stack determines whether the specific service is among the one or more advertised services based on the first information and the second information. If the specific service is among the one or more services, the transport protocol stack may automatically establish, for the client, a transport connection to the server in order to request the specific service.

In one feature of the aspect, the first information comprises one or more server identifiers of the server and a service identifier, which may comprise a bitmap of one or more bits that are associated with one or more services. The first information may also comprise one or more data items for authenticating the server, such as, for example, a password, a shared secret, a Protected Access Credential (PAC), or an encryption key.

In one aspect, the present invention comprises a method for transport level server advertisement and discovery. A transport protocol stack of a first network element receives a data item that includes first information. The transport protocol stack recognizes that the first information represents one or more services that are provided by a second network element. Based on the first information, the protocol stack determines whether any client among one or more clients executing on the first network element and utilizing the transport protocol stack is interested in any service of the one or more services.

In one feature of the aspect, the transport protocol stack notifies a particular client of the one or more clients about a particular service of the one or more services in response to determining that the particular client is interested in the particular service. The transport protocol stack sends the first information to the particular client. Based on the first information, a transport connection to the second network element is established in order to request the particular service. In one feature, the particular client is a Border Gateway Protocol (BGP) process that executes on the first network elements, and the particular service is a second BGP process executing on the second network element.

In a feature of this aspect, the transport protocol stack is a Stream Control Transmission Protocol (SCTP) stack, the data unit is a SCTP packet, and the first information is a SCTP chunk included in the SCTP packet.

In one feature of the aspect, the transport protocol stack is a Transmission Control Protocol (TCP) stack, the data unit is a TCP segment, and the first information is an OPTIONS flag included in the TCP segment.

In a feature of this aspect, the data unit is included in a packet that is transmitted from the second network element in a point-to-point transmission, a multicast transmission, and a broadcast transmission.

In one feature of the aspect, the one or more services provided by the second network element utilize a transport protocol stack that is executing on the second network element.

In a feature of this aspect, the second network element sends the first information to a third network element. The third network element stores the first information in the data unit and sends the data unit to the first network element. The transport protocol stack receives the data unit from the third network element in a point-to-point transmission, a multicast transmission, and a broadcast transmission.

In other aspects, the invention encompasses a computer apparatus and a computer-readable medium configured to carry out the foregoing steps.

2.0 Structural and Functional Overview

A “transport protocol stack” is an entity executing in a computer system that processes the data items it receives according to a transport layer protocol. The transport protocol stack may be implemented in a variety of ways including, but not limited to, an Operating System (OS) process, a user process, a software application, a background process (daemon), a library of functions, and a dynamic link library (DLL).

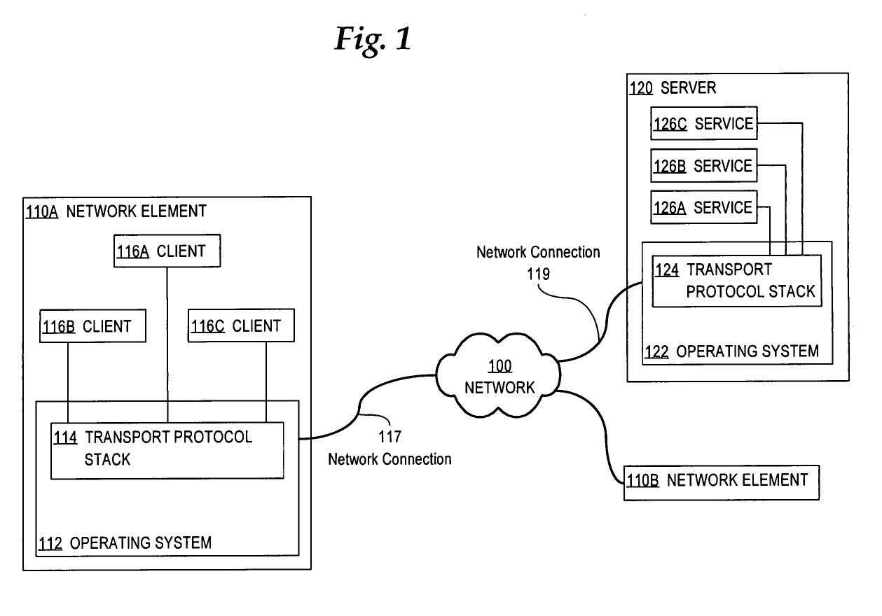

FIG. 1 is a block diagram that illustrates an overview of an operational context in which an embodiment may be implemented. Server 120 is communicatively connected to network 100, and comprises operating system 122, which includes transport protocol stack 124. In other embodiments, transport protocol stack 124 may be executing as a separate transport protocol agent in a user memory space that is separate from the operating system.

Server 120 offers one or more services, such as, for example, services 126A, 126B, and 126C. The one or more services may also be communicatively and/or operatively connected to transport protocol stack 124, and may use transport protocol stack 124 to communicate with clients that request them. The one or more services may be any services that can be offered by a computer system including, but not limited to, any Operating System (OS) services (such as, for example, Remote Procedure Calls (RPCs) service), network routing services (such as, for example, Border Gateway Protocol (BGP) service, Routing Information Protocol (RIP) service, and Open Shortest Path First (OSPF) service), dynamic configuration services (such as, for example, Dynamic Host Configuration Protocol (DHCP) service), web-related services (such as, for example, HyperText Markup Protocol (HTML) service), file and directory services (such as, for example, File Transfer Protocol (FTP) service), network management services (such, as for example, Simple Network Management Protocol (SNMP) service), database services (such as, for example, Database Management System (DBMS) service), e-mail related services (such as, for example, Simple Mail Transfer Protocol (SMTP) service), authentication and authorization services (such as, for example, Kerberos authentication service), Internet Relay Chat (IRC) services, print services, and fax services.

For example, in one embodiment the service may be a Border Gateway Protocol (BGP) process that is executing on a router. The BGP process may be using a Transmission Control Protocol (TCP) to exchange routing information with one or more clients, which may be peer BGP processes that are executing on different network elements or routers.

Network element 110A is communicatively connected to network 100, and comprises operating system 112, which includes transport protocol stack 114. One or more clients, such as clients 116A, 116B, and 116C are communicatively and/or operatively connected to transport protocol stack 114, and use transport protocol stack 114 to request one or more services over network 100. In one embodiment, each one of clients 116A, 116B, and 116C may also register with transport protocol stack 114 a set of one or more services in which the particular client is interested.

In different embodiments, a network element may be any computer system or device that is communicatively connected to a network. The clients may be any entities that execute on the network element and that are capable of using the transport protocol stack on the network element to exchange information with other network elements. Examples of clients include, but are not limited to, any software applications, OS processes, daemons, device drivers, and any processes executing in the user space of the network element. Thus, the techniques described herein are not limited to any particular network elements, servers, services, or clients, and the examples provided herein are to be viewed in an illustrative rather than a restrictive sense.

In operation, in one embodiment server 120 sends first information advertising one or more services offered by server 120 over the transport protocol supported by transport protocol stack 124. The first information includes a bitmap that represents the one or more services. The first information is sent to one or more network elements, such as network elements 110A and 110B, in a point-to-point (unicast), multicast or broadcast transmission over network connection 119. The first information may be stored in a transport protocol data unit that is included in the payload portion of a network layer protocol packet.

For example, the first information may be stored in a transport protocol data unit that is included in a network protocol packet such as an Internet Protocol version 4 (IPv4) packet or an Internet Protocol version 6 (IPv6) packet. The network protocol packet may be transmitted in any type of a broadcast, unicast, or multicast transmission, such as, for example, IPv4 multicast or IPv6 link-local multicast. In one embodiment, the transport protocol over which the services are offered is not UDP, and the first information is not sent to the one or more network elements in a UDP datagram that is broadcast on network connection 119.

At network element 110A, transport protocol stack 114 receives the first information over network connection 117. Transport protocol stack 114 recognizes that the first information represents one or more services offered by a server. In some embodiments, in response to recognizing that the first information represents one or more offered services, transport protocol stack 114 passes the first information up to clients 116A, 116B, and/or 116C, and each client makes a decision whether to establish a transport connection in order to use any of the offered services. In other embodiments, transport protocol stack 114 determines, based on the first information, whether any of clients 116A, 116B, and 116C is interested in any service, and if any client is interested in any service, transport protocol stack 114 automatically establishes a transport connection to that service on behalf of the client.

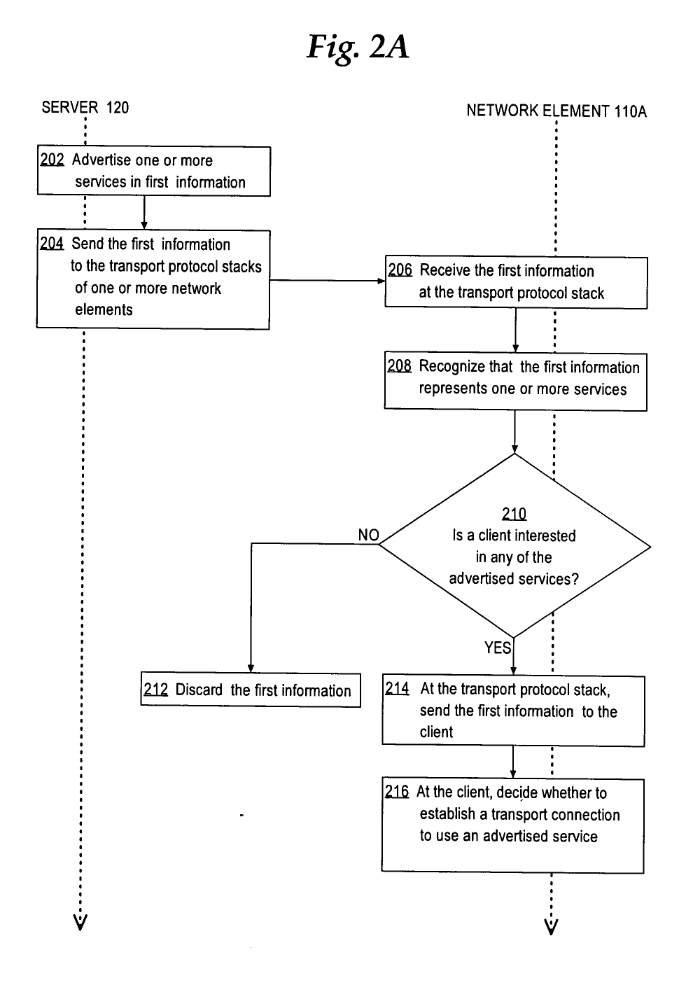

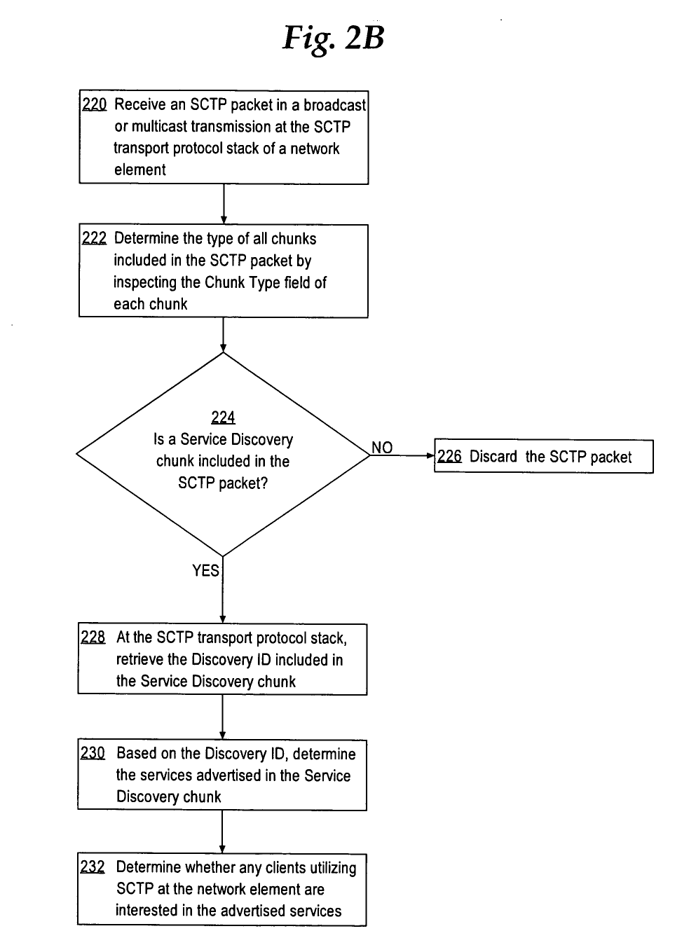

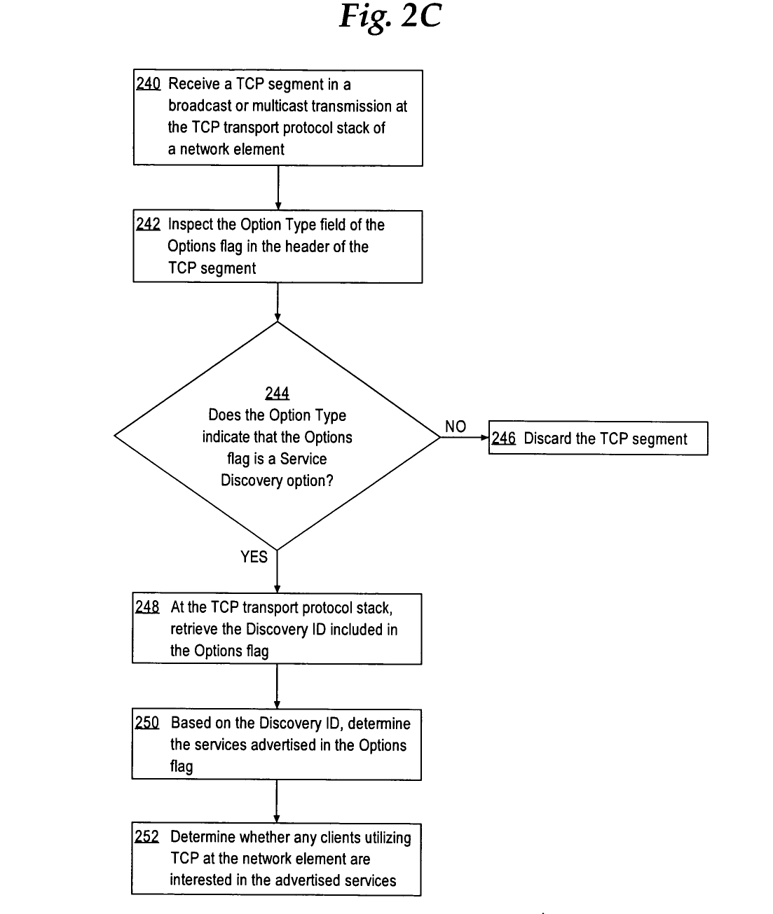

FIG. 2A is a flow diagram that illustrates a high level overview of one embodiment of a method for transport level server advertisement and discovery. In step 202, a server that offers one or more services, such as server 120 depicted in FIG. 1, advertises the one or more services in first information. The first information may represent one or more specific services and may include parameters that are used by a client when the client connects to a particular service. Alternatively, or in addition to, the first information may indicate a general type of service provided by the server, such as, for example, a general type of network routing services. In this example, the general type of network routing services may include specific services for supporting BGP, OSPF, RIP, and/or Intermediate System-to-Intermediate System (IS-IS) protocol. The first information may use a bitmap where each bit represents a particular service and/or a type of service, or it may use any other coding scheme that is known to the client and is capable of indicating that one or more services are being offered.

In step 204, the first information is sent to the transport protocols stacks of one or more network elements in unicast, broadcast, multicast, or any other type of network flooding transmission. In step 206, the transport protocol stack of a network element, such as network element 110A depicted in FIG. 1, receives the first information.

In step 208, the transport protocol stack recognizes that the first information represents one or more services. In one embodiment, the transport protocol stack operates according to SCTP. In this embodiment, the first information is included in a SCTP Service Discovery chunk. The transport protocol stack receives the chunk and, based on the chunk type, recognizes that the chunk carries information representing one or more offered services. In another embodiment, the transport protocol stack operates according to TCP. In this embodiment, the first information is included in the Options flag parameter that is included in the header of a TCP segment. The transport protocol stack receives the TCP segment and, based on the type of the Options flag in the segment header, recognizes that the TCP header carries information representing one or more offered services.

In step 210 the transport protocol stack determines whether any client, which executes on the network element and uses the transport protocol stack for communicating, is interested in any of the services advertised in the first information. In one embodiment, the transport protocols stack determines whether a client is interested in any service by matching data included in the first information to data the transport protocol stack has previously received from the clients. If the transport protocol stack determines that no client is interested in any services represented in the first information, in step 212 the transport protocol stack discards the first information.

If in step 212 the transport protocol stack determines that a client is interested in a service advertised in the first information, then, in one embodiment, the transport protocol stack sends the first information to the interested client in step 214. In step 216, based at least in part on the first information, the client decides whether to establish a transport connection over the transport protocol of the transport protocol stack to the advertised service. Depending on the type of service and the identity of the server offering the service, the client may also request authentication and/or verification of the service by the server before establishing the transport connection.

In one embodiment, if the transport protocol stack determines that a client is interested in a service advertised in the first information, the transport protocol stack may automatically establish a transport connection to the service on behalf of the client. Any security concerns related to the automatic establishment of a transport connection by the transport protocol stack may be resolved by recognizing that the first information is received in a secured communication or from a trusted network element. Alternatively, or in addition to, any security concerns may be resolved by providing in the first information means for authenticating or verifying the service to the client, such as, for example, a password, a shared secret, a Protected Access Credential (PAC), or an encryption key for encrypting any communications sent to the service.

3.0 Method of Transport Level Server Advertisement and Discovery

The approaches described here allow a client executing on a network element to determine whether it is interested in one or more services advertised in first information that is received at the transport protocol stack of the network element.

For example, in one embodiment the transport protocol stack at a network element receives first information and recognizes that the first information represents one or more services provided by a server over the network. The transport protocol stack passes up the first information to a client that executes on the network element. The client determines whether it is interested in any of the services advertised in the first information. If the client is interested in a particular service, then the client establishes a transport connection to that service.

In one embodiment, the client may register with the transport protocol stack second information that indicates one or more services in which the client is interested. When the first information is received at the transport protocol stack, the transport protocol stack recognizes that the first information represents one or more services provided by a server. The transport protocol stack then determines, based on the first information and the second information, whether any of the services in which the client is interested is among the advertised services. If any of the services in which the client is interested is among the advertised services, the transport protocol stack passes the first information to the client. The client then may decide whether to establish a transport connection, over the transport protocol supported by the transport protocol stack, to use the service.

In this way, the decision of whether a client is to use a particular service offered over the network is made without the assistance of a middle layer. The transport protocol stack at a network element determines whether a service advertised by a server is of interest to any clients executing on the network element. Further, a client executing on the network element needs to send only a single communication to establish a transport connection to a particular service and does not need to send multiple communications to discover the particular service.

In one embodiment, the transport protocol stack operates according to SCTP. In this embodiment, the first information is stored in a SCTP Service Discovery chunk that is included in a SCTP packet. In another embodiment, the transport protocol stack operates according TCP. In this embodiment, the first information is stored in an Options flag that is included in the header of a TCP packet. The techniques described herein, however, may be implemented with any connection-oriented transport protocol, and for this reason the examples of connection-oriented transport protocols provided herein are to be regarded in an illustrative rather than restrictive sense.

3.1 Server Advertisement and Discovery over SCTP

In one embodiment, the techniques described herein are implemented according to SCTP. A Service Discovery chunk is stored in a SCTP packet that is included in a network protocol data unit sent in a point-to-point, multicast, or broadcast transmissions over a network. The Service Discovery chunk includes first information that represents one or more services provided by a server over the network. When an SCTP transport protocol stack at a network element receives an SCTP packet that includes a Service Discovery chunk, the SCTP transport protocol stack examines the contents of the Service Discovery chunk before deciding whether to discard it.

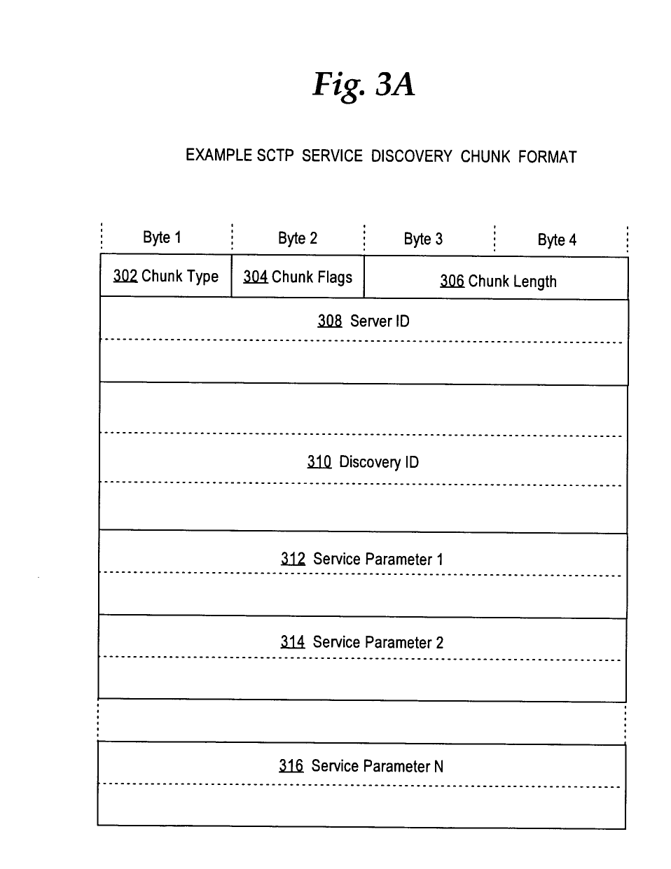

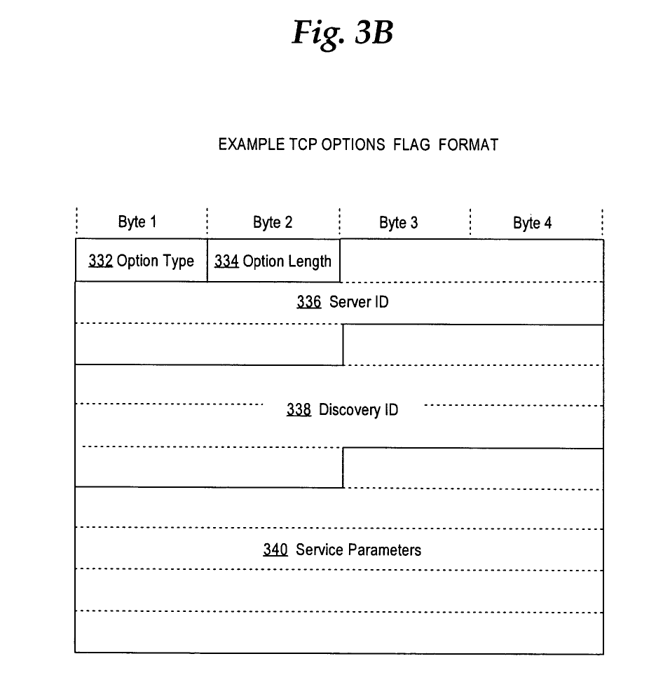

FIG. 3A is block diagram that illustrates the format of an SCTP Service Discovery chunk according to one embodiment. SCTP Service Discovery chunk format is depicted in FIG. 3A in multiples of 4 bytes. The Service Discovery chunk follows the general format of a chunk as required by the SCTP protocol, and includes all fields required by an SCTP chunk.

The Service Discovery chunk includes the standard chunk fields, such as Chunk Type field 302, Chunk Flags field 304, and Chunk Length field 306. The Service Discovery chunk also includes Server ID field 308, Discovery ID field 312, and one or more Service Parameter fields, such as fields 312, 314, and 316.

Chunk Type field 302 stores information that uniquely identifies the type of the chunk. In one embodiment, the value stored in Chunk Type field 302 is an 8-bit value that uniquely distinguishes the Service Discovery chunk from other types of SCTP chunks, such as, for example, Data chunks or Init chunks. In this embodiment, the Chunk Type value of the Service Discovery chunk is assigned by the Internet Assigned Numbers Authority (IANA). Other embodiments may use a Chunk Type value for the Service Discovery chunk that is not assigned by IANA, but is rather a value reserved for private use. The SCTP protocol stack uses the information stored in Chunk Type field 302 to recognize that one or more services are advertised in a Service Discovery chunk.

Chunk Flags field 304 is a standard SCTP chunk field for storing values that define one or more flags used by the particular chunk type. In one embodiment, the Chunk Flags field 304 stores an 8-bit value that represents the flags defined for a Service Discovery type of chunk. Chunk Length field 306 is also a standard SCTP chunk field for storing a value that indicates the length of the particular chunk in bytes.

Server ID field 308 stores a value identifying the server that provides the one or more services which are advertised in the Discovery ID field. In one embodiment, the value stored in Server ID field 308 is two 32-bit integers that are used to uniquely identify the server that offers the service. The Server ID value is used to indicate the source of the services in a situation where the advertisement of the one or more services offered by the server is forwarded by network elements that receive the advertisement.

In this embodiment, when the server offering the one or more services starts its SCTP transport protocol stack, it randomly generates two 32-bit integers and uses them as its Server ID for as long as the SCTP transport protocol stack is running. The server then stores the Server ID value in the Server ID field of any Service Discovery chunk that the server sends for advertising its services. When a network element receives a Service Discovery chunk that advertises the services of the server, the network element may forward the services offered by the server in a “split horizon” fashion, that is, the network element may forward the Service Discovery chunk it received to any network element except the network element that hosts the server sending the original advertisement. The decision whether to forward the received Service Discovery chunk to a particular network element is based on whether the Server ID value in the chunk matches the Server ID value associated with the SCTP transport protocol stack of the particular network element. If the Server ID in the Service Discovery chunk matches the Server ID associated with the SCTP transport protocol stack of the particular network element, then the particular network element is the source of the offered services and the Service Discovery chunk is not forwarded to this particular network element.

Discovery ID field 310 stores a value identifying one or more services offered by a server. In one embodiment, the value stored in Discovery ID field 310 comprises three unsigned 32-bit integers that represent a bitmap in which each bit is associated with a particular service or a general type of service provided by the server. In this embodiment, any potential clients of the server know the encoding of the services and/or the service types beforehand. In other embodiments, any techniques of representing the one or more services may be used. For example, the services may be represented as Type-Length-Value (TLV) parameters, and the Service Discovery chunk may include a separate TLV parameter for each service and/or type of service. In another example, the services may be represented by information in a Data chunk that is sent with the Service Discovery chunk in the same SCTP packet. Thus, the techniques described herein for representing the one or more services provided by a server are to be regarded in an illustrative rather than a restrictive sense.

The Service Discovery chunk may also include one or more Service Parameter fields, such as Service Parameter fields 312, 314, and 316, for storing information that is associated with the one or more services advertised in the Discovery ID field. In one embodiment, the Service Parameters of a Service Discovery chunk may be optional SCTP chunk parameters that are formatted as TLV triplets. The information stored in any Service Parameters may be any service-related information that may be used by a client to connect to a particular service. For example, the service-related information may be a Pretty-Good-Privacy (PGP) key that must be used by a client to encrypt any information sent to the particular service. In another example, the service-related information may include any socket information associated with the particular service, such as, for example, a network address and a port number. Thus, the service-related information stored in the Service Parameter fields of a SCTP Service Discovery chunk depends on the particular service offered and is not limited to any particular type or format of information.

FIG. 2B is a flow diagram that illustrates one embodiment of a technique for transport level service discovery implemented according to SCTP.

In this embodiment, in step 220 a SCTP transport protocol stack at a network element receives a SCTP packet that is broadcasted or multicasted over the network. Since SCTP packets received in broadcast or multicast transmissions usually do not belong to any SCTP association maintained by the SCTP transport protocol stack for the network element, broadcasted or multicasted SCTP packets are usually discarded by the SCTP transport protocol stack. However, in this embodiment the SCTP transport protocol stack examines broadcasted or muslticasted SCTP packets to determine whether any services provided by a server on the network are advertised in the packets.

In this embodiment, in step 222 the SCTP transport protocol stack determines the types of all chunks included in the received SCTP packet by inspecting the Chunk Type field of each chunk. In step 224, based on the inspected Chunk Type fields, the SCTP transport protocol stack determines whether a Service Discovery chunk is included in the SCTP packet. If a Service Discovery chunk is not included in the SCTP packet, in step 226 the SCTP packet is discarded.

If in step 224 the SCTP transport protocol stack determines that a Service Discovery chunk is included in the SCTP packet, in step 228 the SCTP transport protocol stack retrieves the contents of the Discovery ID field included in this chunk. Based on the contents of the Discovery ID field, in step 230 the SCTP transport protocol stack determines the services or type of services that are advertised in the Service Discovery chunk. In step 232, the SCTP transport protocol stack determines whether any clients utilizing the SCTP stack at the network element are interested in any of the advertised services.

3.2 Server Advertisement and Discovery over TCP

In one embodiment, the techniques described herein are implemented according to TCP. An Options flag stored in the header of a TCP segment includes first information that represents one or more services provided by a server over the network. When a TCP transport protocol stack at a network element receives the TCP segment in a point-to-point, multicast, or broadcast transmission, the TCP transport protocol stack examines the contents of the Options flag before deciding whether to discard the TCP segment.

A TCP Options flag typically occupies space at the end of a TCP header. The Options flag begins on an octet boundary and is a multiple of 8 bits in length. The typical length of an Options flag is 40 bytes. FIG. 3B is block diagram that illustrates the format of a TCP Options flag according to one embodiment. In this embodiment, the TCP Options flag includes Option Type field 332, Option Length field 334, Server ID field 336, Discovery ID 338, and Service Parameters field 340.

Option Type field 332 stores information that uniquely identifies the type of the TCP Option. The TCP transport protocol stack at a network element uses the value stored in the Option Type field of a received TCP segment to recognize that one or more services are advertised in the segment. In one embodiment, the value stored in the Option Type field is an 8-bit value that uniquely distinguishes the TCP Option used for service discovery from other types of TCP Options. In this embodiment, the Option Type value is assigned by IANA. Other embodiments may use Option Type values that are not assigned by IANA. For example, since normally a TCP segment that is received over a broadcast transmission is discarded because it does not belong to an established TCP session, a particular TCP implementation may determine that one or more services are advertised in an Options flag just by receiving the Options flag in a TCP segment that is sent in a broadcast transmission.

Option Length field 334 stores a value that indicates the length of the particular Options flag in bytes.

Similarly to the Server ID field described above with respect to SCTP, Server ID field 336 stores a value identifying the server that provides the one or more services which are advertised in the Discovery ID field of the TCP Options flag. In one embodiment, the values stored in Server ID field 336 are in the same format as the Server ID values described above with respect to SCTP. In this embodiment, the value stored in Server ID field 336 is two 32-bit integers that are randomly generated when the TCP transport protocol stack starts. The value stored in Server ID field 336 is used to uniquely identify the server that offers the service or services represented in Discovery ID field 338. The Server ID value is used to indicate the source of the services in a situation where the advertisement of the one or more services offered by the server is forwarded in a “split horizon” manner by network elements that receive the advertisement.

Similarly to the Discovery ID field described above with respect to SCTP, Discovery ID field 338 stores a value identifying one or more services offered by a server. In one embodiment, the value stored in Discovery ID field 338 comprises three unsigned 32-bit integers that represent a bitmap in which each bit is associated with a particular service or a general type of service provided by the server. In this embodiment, any potential clients of the server know the encoding of the services and/or the service types beforehand.

Similarly to the Service Parameters field described above with respect to SCTP, Service Parameter field 340 may store information that is associated with the one or more services represented in Discovery ID field 338. In one embodiment, the Service Parameter field of a TCP Options flag may include any service-related information that is used by a client that connects to a particular service, such as, for example, a PGP key, a password, a shared secret, or a Protected Access Credential (PAC).

FIG. 2C is a flow diagram that illustrates one embodiment of a technique for transport level service discovery implemented according to TCP.

In this embodiment, in step 240 a TCP transport protocol stack at a network element receives a TCP segment. The TCP segment may be received in a network protocol data unit, such as, for example, an IP packet, that is broadcasted or multicasted on the network.

In step 242, the TCP transport protocol stack inspects the Option Type field of the Options flag included in the header of the TCP segment. The TCP transport protocol stack determines whether the Option Type indicates that the Options flag is a TCP Service Discovery option that advertises one or more services provided by a server on the network. If the Option Type does not indicate that the Options flag is a TCP Service Discovery option, in step 246 the TCP transport protocol stack discards the TCP segment.

If in step 244 the TCP transport protocol stack determines that the Options flag of the received TCP segment is a TCP Service Discovery option, in step 248 the TCP transport protocol stack retrieves the contents of the Discovery ID field included in the Options flag. Based on the contents of the Discovery ID field, in step 250 the TCP transport protocol stack determines the services or type of services that are advertised in the Options flag. In step 252, the TCP transport protocol stack determines whether any clients utilizing the TCP stack at the network element are interested in any of the advertised services.

3.3 Forwarding Service Advertisements

In one embodiment, the transport protocol stack at a network element may forward (or re-advertise) first information received from a server, which first information advertises one or more services provided by the server. For example, if the transport protocol stack at the network element is an SCTP transport protocol stack, then the Service Discovery chunk that stores the information advertising the one or more services may be forwarded to one or more other network elements. If the transport protocol stack is a TCP transport protocol stack, then the Options flag advertising the services that was received from the server may be forwarded in a TCP segment that is broadcast or unicast to one or more other network elements.

For example, a network element in a Local Area Network (LAN) may receive first information advertising services provided by a server local to the LAN. The network element may then forward the first information to other network elements on the same LAN, or may forward the advertisement to a list of network elements in other LANs.

In one embodiment, a network element that is using a transport protocol over IPv6 network protocol may use IPv6 Link-Local Broadcast to forward first information advertising one or more services to any network element on the local LAN except the sender of the first information. In addition, the network element may use the Server ID included in the first information to also exclude the provider of the services from the broadcast according to the “split horizon” techniques described herein.

In an embodiment, a network element that receives first information advertising one or more services may keep a list of network elements to which the first information needs to be forwarded. In this embodiment, instead of broadcasting the first information, the network element may send the first information only to the network elements on the list in a multicast transmission, or in point-to-point transmissions to each network element on the list.

4.0 Implementation Mechanisms—Hardware Overview

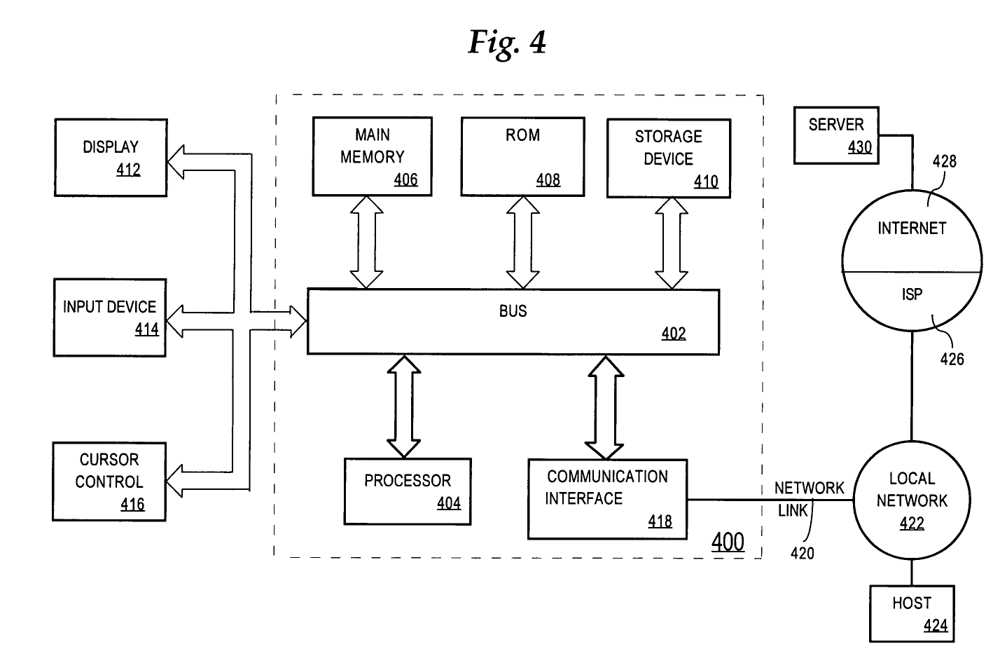

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (“RAM”) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (“ROM”) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (“CRT”), for displaying information to a computer user. An input device 414, including alphanumeric and other keys, is coupled to bus 402 for communicating information and command selections to processor 404. Another type of user input device is cursor control 416, such as a mouse, trackball, stylus, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for transport level server advertisement and discovery. According to one embodiment of the invention, for transport level server advertisement and discovery is provided by computer system 400 in response to processor 404 executing one or more sequences of one or more instructions contained in main memory 406. Such instructions may be read into main memory 406 from another computer-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infrared transmitter to convert the data to an infrared signal. An infrared detector can receive the data carried in the infrared signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (“ISDN”) card or a modem to provide a data communication connection to a corresponding type of telephone line. As another example, communication interface 418 may be a local area network (“LAN”) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (“ISP”) 426. ISP 426 in turn provides data communication services through the worldwide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418. In accordance with the invention, one such downloaded application provides for transport level server advertisement and discovery as described herein.

The received code may be executed by processor 404 as it is received, and/or stored in storage device 410, or other non-volatile storage for later execution. In this manner, computer system 400 may obtain application code in the form of a carrier wave.

5.0 Extensions and Alternatives

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method of transport level server advertisement and discovery, the method comprising the computer-implemented steps of:
receiving first information at a transport protocol stack;
recognizing in the transport protocol stack that the first information represents one or more services that are provided by a server; and
based on the first information, determining at the transport protocol stack whether to use any of the one or more services.

2. A method as recited in claim 1, wherein the transport protocol stack operates according to a connection-oriented transport protocol.

3. A method as recited in claim 1, wherein:
determining whether to use of any of the one or more services further comprises notifying a client about the one or more services, wherein the client utilizes the transport protocol stack; and
the method further comprises, in response to a decision by the client to make use of a particular service of the one or more services, establishing a transport connection to the server in order to request the particular service.

4. A method as recited in claim 3, wherein notifying the client about the one or more services comprises sending the first information to the client.

5. A method as recited in claim 3, wherein the client requests, after establishing the transport connection to the server, authentication of the particular service from the server.

6. A method as recited in claim 1, further comprising:
registering second information with the transport protocol stack, wherein the second information indicates a specific service in which a client that utilizes the transport protocol stack is interested; and
determining, based on the first information and the second information, whether the specific service is among the one or more services.

7. A method as recited in claim 6, wherein the transport protocol stack automatically establishes, for the client, a transport connection to the server in order to request the specific service, if the specific service is among the one or more services.

8. A method as recited in claim 1, wherein the first information comprises:
one or more server identifiers of the server; and
a service identifier, wherein the service identifier comprises a bitmap of one or more bits that are associated with the one or more services.

9. A method as recited in claim 1, wherein the first information comprises one or more data items for authenticating the server.

10. A method as recited in claim 9, wherein the one or more data items comprise any one of a password, a shared secret, a Protected Access Credential (PAC), and an encryption key.

11. A method of transport level server advertisement and discovery, the method comprising the computer-implemented steps of:
at a transport protocol stack of a first network element, receiving a data unit that includes a first information;
recognizing in the transport protocol stack that the first information represents one or more services that are provided by a second network element; and
based on the first information, determining at the transport protocol stack whether any client among one or more clients executing on the first network element is interested in any service of the one or more services, wherein the one or more clients utilize the transport protocol stack.

12. A method as recited in claim 11, further comprising notifying a particular client of the one or more clients about a particular service of the one or more services in response to determining that the particular client is interested in the particular service.

13. A method as recited in claim 12, further comprising:
sending the first information to the particular client; and
based on the first information, establishing a transport connection to the second network element by the particular client in order to request the particular service.

14. A method as recited in claim 12, wherein the particular client is a first Border Gateway Protocol (BGP) process and the particular service is a second BGP process executing on the second network element.

15. A method as recited in claim 11, wherein:
the transport protocol stack is a Stream Control Transmission Protocol (SCTP) stack;
the data unit is a SCTP packet; and
the first information is a SCTP chunk included in the SCTP packet.

16. A method as recited in claim 11, wherein:
the transport protocol stack is a Transmission Control Protocol (TCP) stack;
the data unit is a TCP segment; and
the first information is an OPTIONS flag included in the TCP header of the TCP segment.

17. A method as recited in claim 11, wherein the data unit is included in a packet that is transmitted from the second network element in any one of a point-to-point transmission, a multicast transmission, and a broadcast transmission.

18. A method as recited in claim 11, wherein:
the transport protocol stack of the first network element is a first transport protocol stack; and
the one or more services provided by the second network element utilize a second transport protocol stack of the second network element.

19. A method as recited in claim 11, wherein:
the second network element sends the first information to a third network element; and
the data unit is received from the third network element, wherein the third network element stores the first information in the data unit.

20. A method as recited in claim 19, wherein the data unit is received from the third network element by any one of a point-to-point transmission, a multicast transmission, and a broadcast transmission.

21. An apparatus for transport level server advertisement and discovery, comprising:
one or more processors;
one or more stored sequences of instructions, which instructions, when executed by the one or more processors, cause the one or more processors to perform the steps of:
receiving first information at a transport protocol stack;
recognizing in the transport protocol stack that the first information represents one or more services that are provided by a server; and
based on the first information, determining at the transport protocol stack whether to use any of the one or more services.

22. An apparatus as recited in claim 21, wherein:
the instructions causing the one or more processors to perform the step of determining whether to use of any of the one or more services further cause the one or more processors to perform the step of notifying a client about the one or more services by sending the first information to the client, wherein the client utilizes the transport protocol stack; and
the instructions further cause the one or more processors to perform the step of establishing, in response to a decision by the client to make use of a particular service of the one or more services, a transport connection to the server in order to request the particular service.

23. An apparatus as recited in claim 22, wherein the client requests, after establishing the transport connection to the server, authentication of the particular service from the server.

24. An apparatus as recited in claim 21, wherein the instructions further cause the one or more processors to perform the steps of:
registering second information with the transport protocol stack, wherein the second information indicates a specific service in which a client that utilizes the transport protocol stack is interested; and
determining, based on the first information and the second information, whether the specific service is among the one or more services;
wherein the transport protocol stack automatically establishes, for the client, a transport connection to the server in order to request the specific service, if the specific service is among the one or more services.

25. An apparatus as recited in claim 21, wherein the first information comprises one or more data items for authenticating the server.

26. An apparatus for transport level server advertisement and discovery, comprising:
one or more processors;
one or more stored sequences of instructions, which instructions, when executed by the one or more processors, cause the one or more processors to perform the steps of:
at a transport protocol stack, receiving a data unit that includes a first information;
recognizing in the transport protocol stack that the first information represents one or more services that are provided by a network element; and
based on the first information, determining at the transport protocol stack whether any client among one or more clients executing on the apparatus is interested in any service of the one or more services, wherein the one or more clients utilize the transport protocol stack.

27. An apparatus as recited in claim 26, wherein the instructions further cause the one or more processors to perform the steps of:
notifying a particular client of the one or more clients about a particular service of the one or more services in response to determining that the particular client is interested in the particular service;
sending the first information to the particular client; and
based on the first information, establishing a transport connection to the network element by the particular client in order to request the particular service.

28. An apparatus as recited in claim 27, wherein the particular client is a first Border Gateway Protocol (BGP) process and the particular service is a second BGP process executing on the network element.

29. An apparatus as recited in claim 26, wherein:
the transport protocol stack is a Stream Control Transmission Protocol (SCTP) stack;
the data unit is a SCTP packet; and
the first information is a SCTP chunk included in the SCTP packet.

30. An apparatus as recited in claim 26, wherein:
the transport protocol stack is a Transmission Control Protocol (TCP) stack;
the data unit is a TCP segment; and
the first information is an OPTIONS flag included in the TCP header of the TCP segment.

31. An apparatus as recited in claim 26, wherein the data unit is included in a packet that is transmitted from the network element in any one of a point-to-point transmission, a multicast transmission, and a broadcast transmission.

32. An apparatus for transport level server advertisement and discovery, comprising:
means for receiving first information at a transport protocol stack;
means for recognizing in the transport protocol stack that the first information represents one or more services that are provided by a server; and
means for determining at the transport protocol stack whether to use any of the one or more services based on the first information.

33. A computer-readable medium carrying one or more sequences of instructions for transport level server advertisement and discovery, which instructions, when executed by one or more processors, cause the one or more processors to perform the steps of:
receiving first information at a transport protocol stack;
recognizing in the transport protocol stack that the first information represents one or more services that are provided by a server; and
based on the first information, determining at the transport protocol stack whether to use any of the one or more services.
